(19) United States
(12) Patent Application Publication
(10) Pub. No.: US 2003/0083991 A1
(43) Pub. Date: May 1, 2003

(54) Method and apparatus for tracking and billing cellular roaming charges via a data packet network

(76) Inventor: Dan Kikinis, Saratoga, CA (US)

Correspondence Address: CENTRAL COAST PATENT AGENCY, PO BOX 187, AROMAS, CA, 95004, US

(21) Appl. No.: 10/279,476

(22) Filed: Oct. 23, 2002

Related U.S. Application Data
(60) Provisional application No. 60/335,139, filed on Oct. 25, 2001.

(51) Int. Cl. G06F 17/60

(52) U.S. Cl. 705/40

(57) ABSTRACT

A system for tracking and for billing telephony interactions on a data-packet-network has a first telephony network covering a first service region; at least one second telephony network covering a second service region; a billing server connected to the data-packet-network, the data-packet-network bridging the first and second telephony networks; at least one telephony data packet gateway system on each of the telephony networks. In a preferred embodiment, a user subscribing to either the first or second service region as a home region and roaming by placing a call from the disparate service region has the call tracked in the disparate region at the gateway system, the tracked results sent to the billing server wherein the billing server establishes a billing record and renders the record accessible to the user.

### CROSS-REFERENCE TO RELATED DOCUMENTS

The present invention claims priority to a U.S. provisional patent application entitled “GPRS Packet Billing System” Ser. No. 60/335,139, filed Oct. 25, 2001, disclosure of which is included herein in its entirety by reference.

### FIELD OF THE INVENTION

The present invention is in the field of telephony, particularly wireless cellular telephony, and pertains to methods and apparatus using a data-packet-network (DPN)-based billing system for billing customers who roam between service nets.

### BACKGROUND OF THE INVENTION

In the field of wireless telephony communications, cellular customers often place calls from a point that is outside their local service area as identified in their service contracts. Charges, termed roaming charges, are applied in such instances using call tracking and billing techniques that are known in the art.

FIG. 1 shows a typical prior-art telephony environment 100 wherein roaming charges are tracked and billed to a customer. In this example, a publicly switched (PSTN) telephone network 101 connects 2 cellular network regions for communication. These are network A (102) and network B (103). Each network 102 and 103 has a service control point (SCP) 109 and SCP 110 respectively, functioning as demarcation points between the respective cellular networks and the PSTN network 101. PSTN network 101 is illustrated to include local telephony switches 112 and 113. Switch 112 is local to the region of network 103 and switch 113 is local to the region of network 102.

In this example, network A (102) is assumed to be a “home network” and network B (103) is a regionally displaced network providing coverage in a geographic region that is displaced from the covered region of network A. A cellular user or customer 111 is illustrated in both of the network regions A and B. Customer 111 is considered not roaming if he or she places a call from network A, which in this example, is the home network of customer 111. However, if customer 111 places a call from network B then roaming charges are expected to apply. If network B were a home network for user 111 and if user 111 then placed a call from network A then roaming charges would apply.

Each SCP 109 and 110 has an SS-7 link to a billing service center. SS-7 is a well-known protocol for transforming bell telephone signaling into data record format. For example, SCP 109 has an SS-7 link to a billing center 104 and to billing records server 107. Likewise, SCP 110 has an SS-7 link to a billing center 105 and billing records server 108. Billing center 104 handles customer billing for customers whose home network is network A. Billing server 105 handles billing for customers whose home network is network B.

In practice, when customer 111 places a call from network A (home network) regular local charges are sent from SCP 109 to billing server 107 using SS-7 signaling. Network B and billing center 105 are not involved in the transaction. However, when customer 111 places a call from network B, SCP 110 tracks the call and sends the call record to billing center 105. In center 105, server 108 realizes that customer 111 is not home in network B and applies roaming charges. The billing records for customer 111 are passed from center 105 to center 104 through a private billing network 106. Billing server 107 applies the appropriate charges to the bill of customer 111.

A drawback with the telephony-billing environment of this example is that most often the roaming charges do not appear for some time after the use occurs, and therefore cannot be quickly quantified or measured by the user. Therefore, what is clearly needed is an Internet-based telephone billing service and system for cellular telephone customers.

### SUMMARY OF THE INVENTION

IN a preferred embodiment of the present invention a system for tracking and for billing telephony interactions on a data packet network is provided, comprising a first telephony network covering a first service region, at least a second telephony network covering a second service region, a billing server connected to the data packet network, the data packet network bridging the first and second telephony networks, and at least one telephony data packet gateway system on each of the telephony networks. The system is characterized in that a user subscribing to either the first or second service region as a home region and roaming by placing a call from the disparate service region has the call tracked in the disparate region at the gateway system, the tracked results sent to the billing server wherein the billing server establishes a billing record and renders the record accessible to the user.

In a preferred embodiment the data-packet-network is the Internet network. Also in a preferred embodiment one or more of the telephony networks are digital cellular networks. The gateway system may be a general-packet-radio-service gateway.

In some preferred embodiments the tracking method is packet counting. In others the tracking method is word counting. The tracking method may include a time-out threshold of inactivity.

In another aspect of the invention a general-packet-radio-service gateway for gating and tracking telephony calls in a telephony network is provided, comprising a data routing and network address translation module, a SS-7 telephony signaling module, and a counter for counting data packets. This gateway is characterized in that the gateway tracks calls of users that are roaming on the local network and sends the results to a billing entity using the SS-7 protocol.

In preferred embodiments of the gateway a data packet network hosts the billing entity and the billing entity is a data server. Also in some embodiments the data-packet-network is the Internet network. The telephony network may be a digital cellular network having access to other telephony networks through the gateway. In some cases the tracking method is packet counting. In others the tracking method is word counting. The tracking method may also include a time-out threshold of inactivity. In some cases only calls that are accredited to use the network that they are roaming are tracked. Also in some embodiments calls are intercepted and monitored in real-time using at least one counter and/or timer to quantify the call for billing purposes.

In another embodiment of the invention a method for tracking calls placed from a telephony network and recording the call data for billing purposes is provided, comprising steps of (a) providing a call gateway including data routing, network address translation, and packet counting capabilities to host the calls at the demarcation point of the local calling network from which the calls were placed; (b) intercepting a first packet of a first call; (c) sending an inquiry to a billing service about whether the caller has authorized access to roam in the calling network; (d) receiving a response from the billing service regarding caller clearance to use the network; (e) assuming clearance, intercepting subsequent data packets and monitoring them according to security rules; and (f) sending the recorded results to the billing service entity.

In a preferred embodiment, in step (a), the gateway is a general-packet-radio-service gateway and the local calling network is a digital cellular network. Also in a preferred embodiment, in step (a), packet counting includes word counting and a time-out period monitoring inactivity. In another embodiment, in step (b), the first packet is given an identification tag identifying the call. In some cases, in step (c), the billing service is hosted on the Internet network and the inquiry is sent using SS-7 signaling. In some cases, in step (e), the subsequent packets are associated using the same ID given to the first intercepted data packet. Also in some cases, in step (f), the recorded results are packet counting results and are sent to the billing service entity using SS-7 signaling. In other case, in step (f), the billing service entity is a data server on the Internet.

### BRIEF DESCRIPTION OF THE DRAWING FIGURES

FIG. 1 is a block diagram illustrating a billing system network according to prior-art.

FIG. 2 is a block diagram illustrating a billing system according to an embodiment of the present invention.

FIG. 3 is a block diagram illustrating internal components of a GPRS gateway according to an embodiment of the invention.

FIG. 4 is a process-flow diagram illustrating steps for billing according to an embodiment of the invention.

### DESCRIPTION OF THE PREFERRED EMBODIMENTS

According to a preferred embodiment, the inventor provides a billing system for cellular customers, the billing system being DPN-based instead of voice-based.

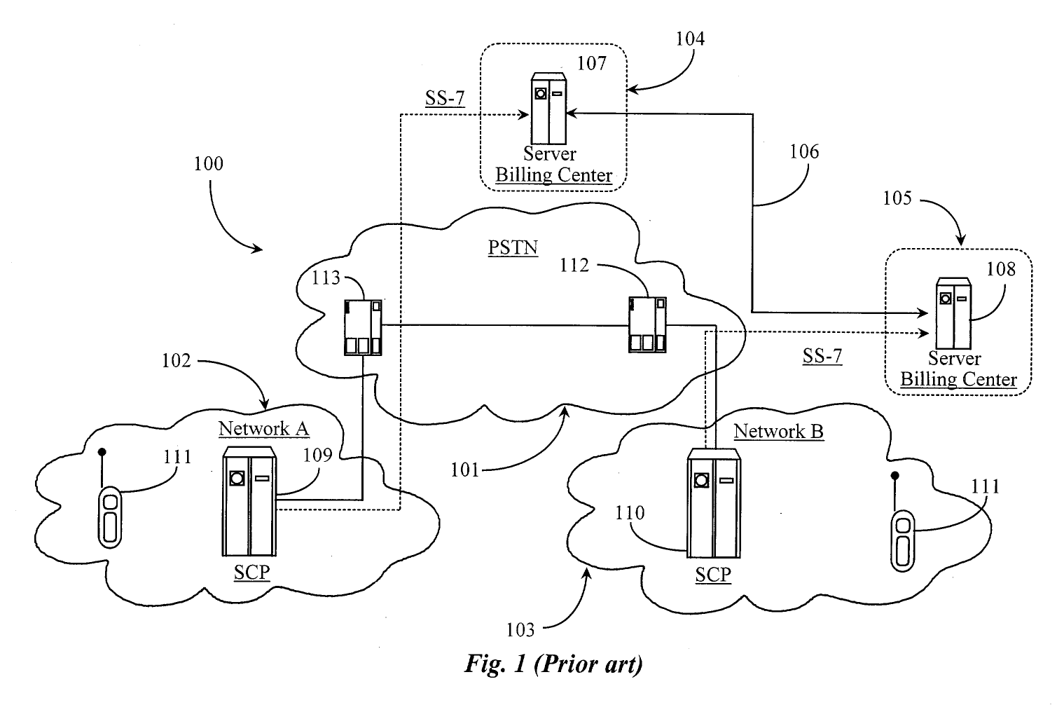

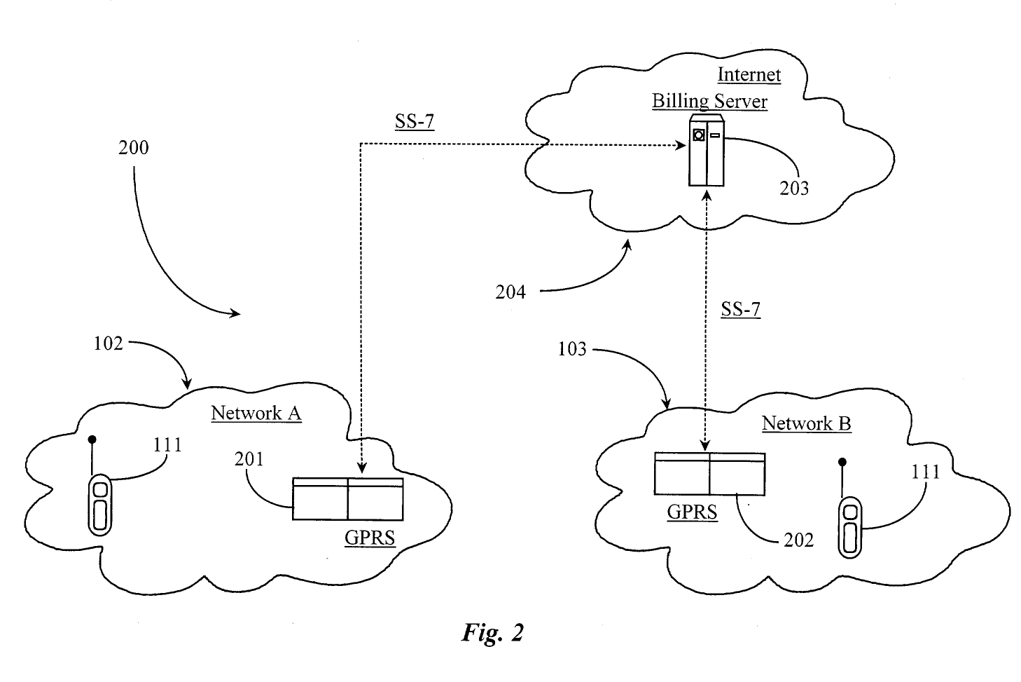

FIG. 2 is a block diagram illustrating a billing system 200 according to an embodiment of the present invention. Billing system 200 comprises networks 102 and 103 of the prior-art example of FIG. 1 described in the background section, and a data packet network 204 (DPN), which in this example is the well-known Internet network. Instead of SCPs 109 and 110 described with reference to FIG. 1 above, general-packet-radio-service (GPRS) gateways are illustrated, one each within networks 102 and 103. GPRS gateway 201 is illustrated as a demarcation point for calls placed from within network 103 and GPRS gateway 202 is illustrated as a demarcation point for calls placed from within network 103.

In this embodiment of the invention, the well-known PSTN network-based billing system is not required. Although actual calls may, in some cases, be bridged through the PSTN network and, of course, may be placed to destination numbers within the PSTN domain, the object of the present invention is to provide a DPN-based accounting of all roaming charges for users, such as user 111. In a preferred embodiment, all calls that will eventually be connected through the PSTN will be first routed through the Internet.

In practice of the present invention, the Internet network 204 provides an intermediary bridge for cellular calls leaving demarcation points 201 and 202. In this way, all calls are packet-oriented for purposes of tracking instead of being PSTN calls, at least at the point of demarcation.

GPRS gateways 201 and 202 contain mechanisms for IP packet accounting of active GPRS sessions (calls). Each gateway 201 and 202 also has an SS-7-capable link for passing session billing records to a single DPN-based billing service center represented in this example as billing server 203 within Internet 204. Server 203 contains the software required for quantifying and isolating the parameters of each cellular network 102 and 103 and can set up billing records for clients subscribed to those networks.

In practice of the present invention, user 111 may place a call from network 102, which is assumed to be a home network in this example, and the call will be intercepted at GPRS gateway 201. Because user 111 is not roaming in this case, GPRS 201 simply facilitates the call request and routes the call accordingly. Because the call is really a data packet session, GPRS 201 and 202 have routing routines including network address translation routines for call accounting and billing purposes. Normal non-roaming call records are uploaded to billing server 203 via the SS-7-capable link. It is noted herein that the SS-7 network link is, in this case, a pure digital link and records are formatted according to SS-7 inter-company billing formats.

Now assuming user 111 is roaming by placing a call from network 103, the call is intercepted at gateway 202. Gateway 202 does not recognize the customer because network 103 is not the home network. Therefore, GPRS 202 sends an inquiry to server 203 to see if customer 111 is accredited or “cleared” to roam on network 103. If a negative response is returned to GPRS gateway 202 from server 203, then customer 111 may be sent an error message such as “service not available”. However, if the inquiry and response transaction clears customer 111 to roam on network 103 then gateway 202 processes the call, which is set up as a GPRS data session.

The initiated session is counted in terms of data packets processed and/or time period allotted depending on the nature of the service agreement between the cellular provider and customer 111. The session is routed through an Internet bridge to destination and the session is monitored. When the session terminates or a period of inactivity is reached, perhaps 15 minutes, gateway 202 immediately transmits the session records to server 203, which in turn calculates the billing and forwards the billing records to gateway 201 over the SS-7 network. Gateway 201 processes the billing from there. In this way, records for roaming charges are almost immediately available to user 111; so that he or she can calculate how much time they really want to spend roaming on a host network that is not their home network.

In cases where there is a roaming ceiling established per day or per session by the roaming clause in a user agreement, a maximum number of packets may be allowed per day or per session to help reduce instances of fraud. At the end of a GPRS session, or when an established session timeout greater than a predetermined duration occurs, the session billing is transferred as a call record with a special identification (ID) for the call type (data) and the associated costs.

In one embodiment, the charge for the usage may be imposed as an airtime charge on the home cellular phone network, which reflects the actual call history. Alternatively, usage may be billed on a once-per-day cycle, for example, cut off at midnight. So if a person were to travel on an overnight trip to another city where he has roaming rights, he would be charged twice. The charges would comprise one billing for day 1 usage and one billing for day 2 usage. The charges would be accrued only for the session activity for each day. The user could have access after day 1 to analyze the record for day 1 and perhaps make adjustments to the activity planned for day 2 ahead of time.

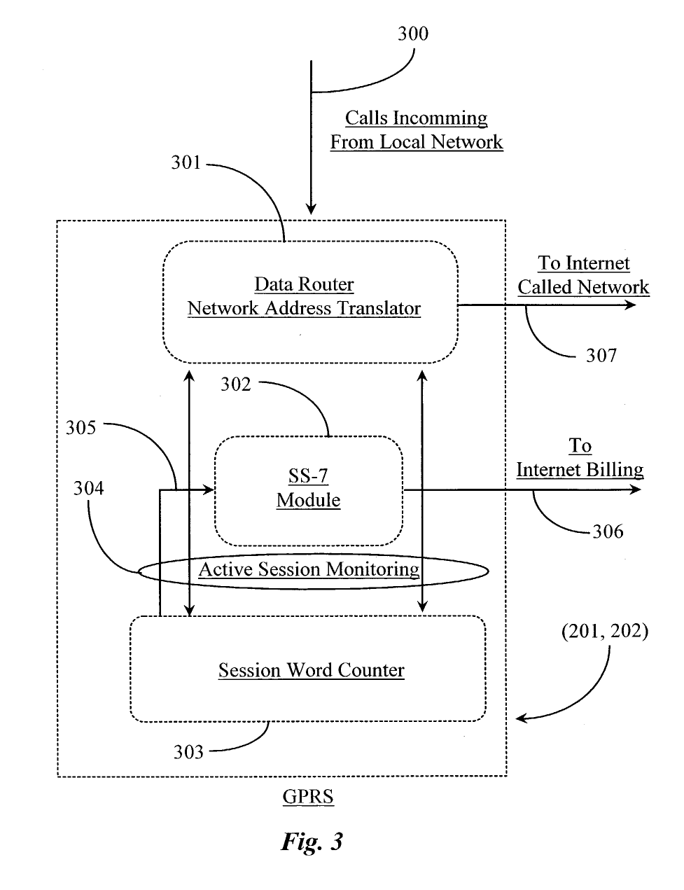

FIG. 3 is a block diagram illustrating internal components of a GPRS gateway (201, 202) of FIG. 2 according to an embodiment of the invention. GPRS gateway (201, 202) receives all calls 300 placed from the domain of the local home cellular network. A data routing and network address translation module. 301 is provided within GPRS gateway (201, 202). Module 301 intercepts the first packets of an incoming session and runs a routine designed to determine if the user is roaming or not. The routine simply makes an inquiry to the billing server over SS-7 link to clear the user if he or she is roaming. If the user is not roaming then he or she does not need clearance. The routine is designed to prevent those not authorized on the host network to use the network. Network address translation is performed for the purpose of routing the session through at least a portion of the Internet on a provided Internet pipeline or access line 307 before bridging to a PSTN or another cellular network.

In the case of all sessions, a session word or packet counter 303 is provided for active session monitoring represented in this example as activity 304. It is noted herein that there will be, in practice, many ongoing GPRS sessions some roaming and some not at any given time. Counter 303 is adapted to track many ongoing data sessions simultaneously.

Counter 303 provides session results for each session to an SS-7 module 302 over an internal port 305. Each session is given a unique ID for identification purposes in billing. There are many known ways to accomplish the task of ID tagging for data sessions. SS-7 module prepares the billing data for each session and uploads the records to the appropriate billing destination hosted, in this case on the Internet via an Internet access link 306. It is noted herein that Internet access links 306 and 307 may be the same link without departing from the spirit and scope of the invention. It is also noted herein that sessions may be identified for billing by module 301, by module 302, or by module 303 without departing from the spirit and scope of the invention.

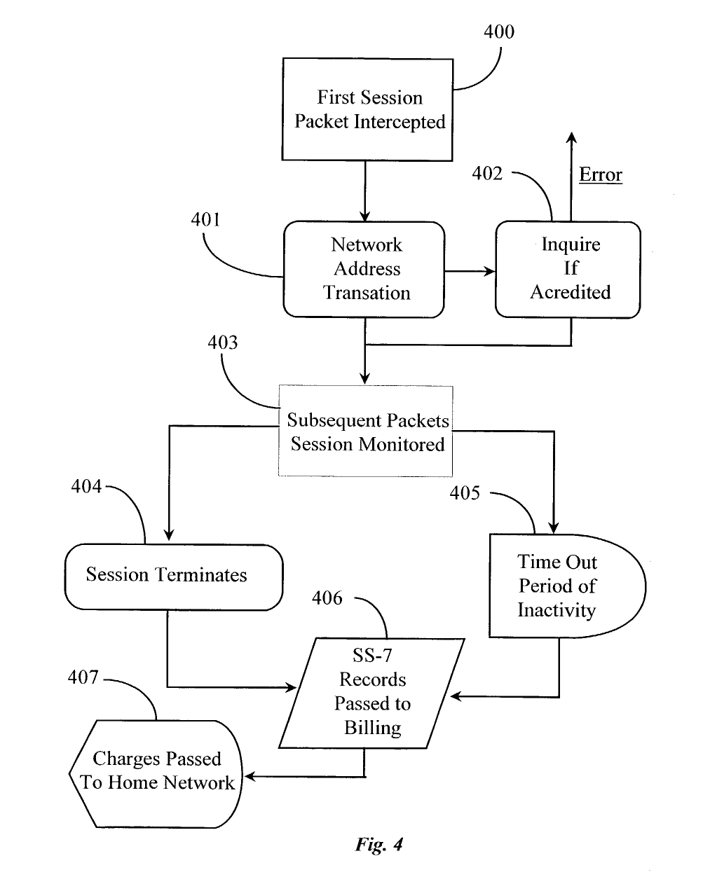

FIG. 4 is a process-flow diagram illustrating steps for billing according to an embodiment of the invention. In step 400, a first data packet from an initiated GPRS session is intercepted at a network GPRS gateway analogous to either gateway 201 or 202 described with reference to FIG. 2. The purpose for packet interception is twofold. For example, in step 401 network address translation and other routing determinations are made. In step 402, which may occur simultaneously with step 401, an inquiry is sent to the billing service to determine if a particular session is cleared for the originating network (roaming). If a response from the billing service is negative, then an error message may be sent to the user. If the response is positive, then in step 403 subsequent data packets of the initiated session are monitored. The monitoring is performed by a session word counter or set of IP (packet) counters. It is noted herein that all sessions whether roaming or not may, in some cases, be monitored for billing purposes. In some cases those sessions initiated from home networks are not monitored because they are considered local in nature and may be covered by other flat-rate provisions in a user contract.

When a session terminates as in step 404, records from session monitoring are generated according to SS-7 protocol and then passed to the billing service in step 406. Because the records reflect roaming charges, in step 407 they are forwarded from the billing service after processing to the user's home cellular network. In an alternative scenario, a service or session timeout is imposed over a period of inactivity in the session, which may be breached at step 405. If this occurs before the session is officially terminated, then the billing records are generated and passed to the billing service center in step 406 and eventually to the user's home network for accessibility in step 407.

The method and apparatus of the invention can be practiced between any wireless cellular networks and interconnecting networks that are DPN oriented. The spirit and scope of the invention should be limited only by the claims that follow.

What is claimed is:

1. A system for tracking and for billing telephony interactions on a data packet network comprising:
a first telephony network covering a first service region;
at least a second telephony network covering a second service region;
a billing server connected to the data packet network, the data packet network bridging the first and second telephony networks; and
at least one telephony data packet gateway system on each of the telephony networks;
characterized in that a user subscribing to either the first or second network as a home network and roaming by making a data connection from another network has that connection tracked in the other network by at least one the gateway systems, the tracked results sent to the billing server wherein the billing server establishes a billing record and renders the record accessible to the user or his home network.

2. The system of claim 1 wherein the data-packet-network is the Internet network.

3. The system of claim 1 wherein one or more of the telephony networks are digital cellular networks.

4. The system of claim 1 wherein the gateway system is a general-packet-radio-service gateway.

5. The system of claim 1 wherein the tracking method is packet counting.

6. The system of claim 1 wherein the tracking method is word counting.

7. The system of claim 1 wherein the tracking method includes a time-out threshold of inactivity.

8. A general-packet-radio-service gateway for gating and tracking telephony calls in a telephony network comprising:
a data routing and network address translation module;
a SS-7 telephony signaling module; and
a counter for counting data packets;
characterized in that the gateway tracks calls of users that are roaming on the local network and sends the results to a billing entity using the SS-7 protocol.

9. The gateway of claim 8 wherein a data packet network hosts the billing entity and the billing entity is a data server.

10. The gateway of claim 9 wherein the data-packet-network is the Internet network.

11. The gateway of claim 8 wherein the telephony network is a digital cellular network having access to other telephony networks through the gateway.

12. The gateway of claim 8 wherein the tracking method is packet counting.

13. The gateway of claim 8 wherein the tracking method is word counting.

14. The gateway of claim 8 wherein the tracking method includes a timeout threshold of inactivity.

15. The gateway of claim 8 wherein only calls that are accredited to use the network they are roaming are tracked.

16. The gateway of claim 9 wherein those calls are intercepted and monitored in real-time using at least one counter and/or timer to quantify the call for billing purposes.

17. A method for tracking calls placed from a telephony network and recording the call data for billing purposes, comprising steps of:
(a) providing a call gateway including data routing, network address translation, and packet counting capabilities to host the calls at the demarcation point of the local calling network from which the calls were placed;
(b) intercepting a first packet of a first call;
(c) sending an inquiry to a billing service about whether the caller has authorized access to roam in the calling network;
(d) receiving a response from the billing service regarding caller clearance to use the network;
(e) assuming clearance, intercepting subsequent data packets and monitoring them according to security rules; and
(f) sending the recorded results to the billing service entity.

18. The method of claim 17 wherein in step (a) the gateway is a general-packet-radio-service gateway and the local calling network is a digital cellular network.

19. The method of claim 17 wherein in step (a) packet counting includes word counting and a time-out period monitoring inactivity.

20. The method of claim 17 wherein in step (b) the first packet is given an identification tag identifying the call.

21. The method of claim 17 wherein in step (c) the billing service is hosted on the Internet network and the inquiry is sent using SS-7 signaling.

22. The method of claim 17 wherein in step (e) the subsequent packets are associated using the same ID given to the first intercepted data packet.

23. The method of claim 17 wherein in step (f) the recorded results are packet counting results and are sent to the billing service entity using SS-7 signaling.

24. The method of claim 17 wherein in step (f) the billing service entity is a data server on the Internet.
